(19) United States
(12) Patent Application Publication
(10) Pub. No.: US 2023/0022295 A1
(43) Pub. Date: Jan. 26, 2023

(54) CONTROL APPARATUS, CONTROL METHOD, AND NON-TRANSITORY COMPUTER READABLE MEDIUM

(71) Applicant: NEC Corparation, Minato-ku,Tokyo (JP)

(72) Inventors: Rintaro KATO, Tokyo (JP); Takeioshi Nakajima, Tokyo (JP); Takeshi Ieiri, Tokyo (JP); Shinichi Anami, Tokyo (JP)

(21) Appl. No.: 17/785,108

(22) PCT Filed: Dec. 26, 2019
(86) PCT No.: PCT/JP2019/051204

§ 371 Date: Jun. 14, 2022

(51) Int. Cl. H04W 36/06; H04W 36/30; H04W 48/16; H04W 72/04; H04W 72/12

(52) U.S. Cl. CPC H04W 36/06; H04W 36/30; H04W 48/16; H04W 72/0453; H04W 72/1273

(57) ABSTRACT

In a control apparatus, a relative value calculation unit calculates a first relative value of a second communication quality parameter value acquired by an acquisition unit relative to a first communication quality parameter value acquired by the acquisition unit. The first communication quality parameter value is a communication quality parameter value for an in-use channel, and the second communication quality parameter value is a communication quality parameter value for a standby channel. Further, a channel switching control unit determines whether or not a radio channel set as the standby channel should be switched from the standby channel to the in-use channel based on a comparison result obtained by comparing the first relative value calculated by the relative value calculation unit and a first threshold.

### TECHNICAL FIELD

The present disclosure relates to a control apparatus, a control method, and a non-transitory computer readable medium.

### BACKGROUND ART

A technology for switching a plurality of connections from one to another based on communication quality has been proposed (e.g., Patent Literature 1). Patent Literature 1 discloses a technology for determining whether or not a communication terminal should switch its connection from a connection with a first radio communication network, which the communication terminal is currently in connection with, to a connection with a second radio communication network by comparing communication quality measured for the connection with the first radio communication network with a threshold.

### CITATION LIST

### Patent Literature

### Patent Literature 1: Japanese Unexamined Patent Application Publication No. 2015-165630

### SUMMARY OF INVENTION

### Technical Problem

The inventors of the present application have found that in the above-described technology disclosed in Patent Literature 1, it is determined whether or not the connection should be switched based solely on the communication quality of the currently-used connection, so there is a possibility that ineffective switching may be performed. That is, the inventors of the present application have found that in the above-described technology disclosed in Patent Literature 1, the communication quality of the connection that will be used after the switching is not taken into consideration at all, so that there is a possibility that ineffective switching may be performed.

An object of the present disclosure is to provide a control apparatus, a control method, and a non-transitory computer readable medium capable of preventing ineffective radio channel switching from being performed and thereby performing effective radio channel switching.

### Solution to Problem

A control apparatus according to a first aspect is a control apparatus configured to control communication of a radio communication apparatus capable of performing communication by using a plurality of radio channels, the control apparatus including:

acquisition means for acquiring a communication quality parameter value for each of a radio channel set as an in-use channel and a radio channel set as a standby channel, the in-use channel being a channel that is currently used for communication, and the standby channel being a channel that is not currently used for the communication;

first relative value calculation means for calculating a first relative value of a second communication quality parameter value relative to a first communication quality parameter value, the second communication quality parameter value being the acquired communication quality parameter value for the standby channel, and the first communication quality parameter value being the acquired communication quality parameter value for the in-use channel; and

channel switching control means for determining whether or not the radio channel set as the standby channel should be switched from the standby channel to the in-use channel based on a comparison result obtained by comparing the calculated first relative value with a first threshold.

A control method according to a second aspect is a control method for controlling communication of a radio communication apparatus capable of performing communication by using a plurality of radio channels, the control method including:

acquiring a communication quality parameter value for each of a radio channel set as an in-use channel and a radio channel set as a standby channel, the in-use channel being a channel that is currently used for communication, and the standby channel being a channel that is not currently used for the communication;

calculating a first relative value of a second communication quality parameter value relative to a first communication quality parameter value, the second communication quality parameter value being the acquired communication quality parameter value for the standby channel, and the first communication quality parameter value being the acquired communication quality parameter value for the in-use channel; and

determining whether or not the radio channel set as the standby channel should be switched from the standby channel to the in-use channel based on a comparison result obtained by comparing the calculated first relative value with a first threshold.

A non-transitory computer readable medium according to a third aspect stores a control program for causing a control apparatus configured to control communication of a radio communication apparatus capable of performing communication by using a plurality of radio channels to perform processes including:

acquiring a communication quality parameter value for each of a radio channel set as an in-use channel and a radio channel set as a standby channel, the in-use channel being a channel that is currently used for communication, and the standby channel being a channel that is not currently used for the communication;

calculating a first relative value of a second communication quality parameter value relative to a first communication quality parameter value, the second communication quality parameter value being the acquired communication quality parameter value for the standby channel, and the first communication quality parameter value being the acquired communication quality parameter value for the in-use channel; and

determining whether or not the radio channel set as the standby channel should be switched from the standby channel to the in-use channel based on a comparison result obtained by comparing the calculated first relative value with a first threshold.

### Advantageous Effects of Invention

According to the present disclosure, it is possible to provide a control apparatus, a control method, and a non-transitory computer readable medium capable of preventing ineffective radio channel switching from being performed and thereby performing effective radio channel switching.

### BRIEF DESCRIPTION OF DRAWINGS

FIG. 1 shows an example of a communication system according to a first example embodiment;

FIG. 2 is a block diagram showing an example of a radio terminal including a control apparatus according to the first example embodiment;

FIG. 3 shows an example of a communication system according to a second example embodiment;

FIG. 4 is a block diagram showing an example of a radio terminal including a control apparatus according to the second example embodiment;

FIG. 5 is a flowchart showing an example of processing operations performed by the control apparatus according to the second example embodiment;

FIG. 6 is a flowchart showing an example of processing operations performed by the control apparatus according to the second example embodiment;

FIG. 7 is a block diagram showing an example of a radio terminal including a control apparatus according to a third example embodiment; and

FIG. 8 shows an example of a hardware configuration of a control apparatus.

### DESCRIPTION OF EMBODIMENTS

An example embodiment will be described hereinafter with reference to the drawings. Note that in the example embodiment, the same or equivalent components are denoted by the same reference numerals (or symbols), and redundant descriptions thereof will be omitted.

### First Example Embodiment

### <Overview of Communication System>

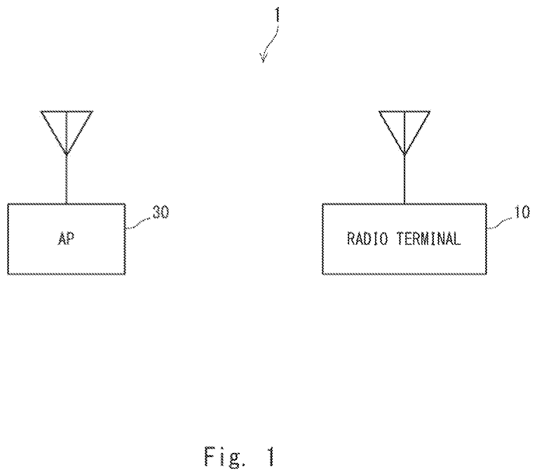

FIG. 1 shows an example of a communication system according to a first example embodiment. The communication system 1 is, for example, a wireless LAN communication system. In FIG. 1, the communication system 1 includes a radio terminal 10 and an access point (AP) 30. It should be noted that although only one radio terminal 10 and only one AP 30 are shown for simplifying the description, the number of radio terminals 10 and the number of APs 30 included in the communication system 1 are each not limited to one.

The radio terminal 10 is configured so as to be able to communicate with the AP 30 by using a plurality of radio channels (hereinafter also referred to as a “first radio channel group”).

Note that the radio terminal 10 selects (sets) a first radio channel from the first radio channel group as an “in-use channel” which is a channel currently used for communication. Therefore, second radio channels, which are channels other than the first radio channel in the first radio channel group, are selected (set) as “standby channels”.

The communication system 1 is, for example, a wireless LAN system. In this case, the radio terminal 10 performs carrier sensing in the “in-use channel”, and transmits a signal at a timing at which no other radio terminal (not shown) transmits a signal (i.e., at an available time other than a busy time).

### Example of Configuration of Radio Terminal

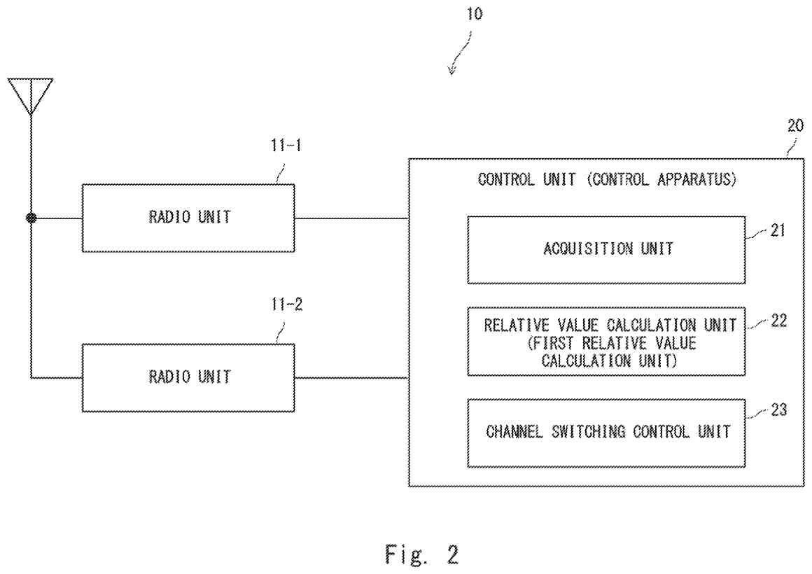

FIG. 2 is a block diagram showing an example of a radio terminal including a control apparatus according to the first example embodiment. In FIG. 2, the radio terminal 10 includes radio units (radio interface units) 11-1 and 11-2, and a control unit (a control apparatus) 20. Note that although one antenna is commonly used by both the radio units 11-1 and 11-2 in the radio terminal 10 shown in FIG. 2, the configuration of the radio terminal 10 is not limited to this example. That is, the radio terminal 10 may include an antenna corresponding to the radio unit 11-1 and an antenna corresponding to the radio unit 11-2, respectively. In the following description, when the radio units 11-1 and 11-2 are not distinguished from each other, the radio units 11-1 and 11-2 may be simply referred to as radio units 11. Although the number of radio units 11 is two in this example, it is not limited to two. That is, the number of radio units 11 may be three or larger.

Each of the radio units 11-1 and 11-2 performs a transmission radio process for a transmission signal and a reception radio process for a reception signal by using a set radio channel. Here, it is assumed that the aforementioned first radio channel is set in the radio unit 11-1, and communication is being performed by the radio unit 11-1. Further, it is assumed that the aforementioned second radio channel is set in the radio unit 11-2, and the radio unit 11-2 is in a standby state.

In FIG. 2, the control unit (the control apparatus) 20 includes an acquisition unit 21, a relative value calculation unit (a first relative value calculation unit) 22, and a channel switching control unit 23.

The acquisition unit 21 acquires a “communication quality parameter value” for each of the radio channel set as the in-use channel and the radio channel(s) set as the standby channel(s). In the following description, the communication quality parameter value for the in-use channel is also referred to as a “first communication quality parameter value” and the communication quality parameter value for the standby channel is referred to as a “second communication quality parameter value”.

The relative value calculation unit 22 calculates a relative value (hereinafter also referred to as a “first relative value”) of the second communication quality parameter value acquired by the acquisition unit 21 relative to the first communication quality parameter value acquired by the acquisition unit 21. The “first relative value” may be a ratio of the second communication quality parameter value to the first communication quality parameter value, or a difference obtained by subtracting the first communication quality parameter value from the second communication quality parameter value.

The channel switching control unit 23 determines whether or not the radio channel set as the standby channel should be switched from the standby channel to the in-use channel based on a comparison result obtained by comparing the first relative value calculated by the relative value calculation unit 22 with a threshold (hereinafter also referred to as a “first threshold”). For example, when the calculated first relative value is larger than the first threshold, the channel switching control unit 23 determines that the radio channel set as the standby channel should be switched from the standby channel to the in-use channel. That is, since it is assumed that, as of this point in time, the first radio channel is the in-use channel and the second radio channel is the standby channel, the channel switching control unit 23 determines to switch the in-use channel from the first radio channel to the second radio channel. Then, the first radio channel becomes a standby channel. Further, the channel switching control unit 23 sets the second radio channel as the in-use channel and sets the first radio channel as the standby channel. As a result, the radio unit 11-2 is used for communication, and the radio unit 11-1 enters a standby state. Note that when the calculated first relative value is lower than or equal to the first threshold, the channel switching control unit 23 may maintain the radio channel set as the in-use channel as it is.

Note that although the above description has been made on the assumption that the “first radio channel group” is composed of a plurality of radio channels of one AP 30, the present disclosure is not limited to this example. The “first radio channel group” may include a plurality of radio channels of one or a plurality of other APs in addition to the plurality of radio channels of the AP 30. That is, a radio channel of the AP 30 may be set as the in-use channel, and a radio channel of the AP 30 or a radio channel of other APs may be set as the standby channel. That is, the above-described first and second radio channels may be radio channels of one AP or radio channels of different APs.

As described above, according to the first example embodiment, in the control apparatus 20, the relative value calculation unit 22 calculates the first relative value of the second communication quality parameter value acquired by the acquisition unit 21 relative to the first communication quality parameter value acquired by the acquisition unit 21. Then, the channel switching control unit 23 determines whether or not the radio channel set as the standby channel should be switched from the standby channel to the in-use channel based on the comparison result obtained by comparing the first relative value calculated by the relative value calculation unit 22 and the first threshold.

By the above-described configuration of the control apparatus 20, it is possible to prevent ineffective radio channel switching from being performed and thereby to perform effective radio channel switching. That is, for example, it is conceivable that the radio channel of the in-use channel is switched on the condition that the received signal strength (i.e., the absolute value) of the in-use channel has decreased beyond a predetermined threshold. In this case, since the communication quality of the standby channel is not taken into consideration, there is a possibility that ineffective switching between radio channels may be performed. Further, in this case, there is a possibility that the radio channel of the in-use channel is maintained in a situation where the received signal strength (i.e., the absolute value) of the in-use channel is slightly larger than the predetermined threshold but the communication quality cannot be considered to be satisfactory (i.e., there is a possibility that the so-called “unsatisfactory state continuation problem” may occur). In contrast to this, by the above-described configuration of the control apparatus 20, it is possible to determine whether or not channel switching needs to be performed based on the comparison result obtained by comparing the first relative value with the first threshold. Therefore, it is possible to switch the radio channel set as the standby channel from the standby channel to the in-use channel when it is expected that, by doing so, the communication quality will be significantly improved, and to prevent the switching from being performed when it is not expected that the communication quality will be significantly improved. Further, the “unsatisfactory state continuation problem” can also be solved by the above-described configuration of the control apparatus 20.

### Second Example Embodiment

In a second example embodiment, firstly, it is determined whether or not channel switching between the in-use channel and the standby channel needs to be performed, and secondly, when it is determined that the channel switching between the in-use channel and the standby channel does not need to be performed, it is determined whether or not a handover for the standby channel needs to be performed. Note that as in the first example embodiment, the radio channels set as the in-use channel and the standby channel may be radio channels of one AP or radio channels of different APs.

### <Overview of Communication System>

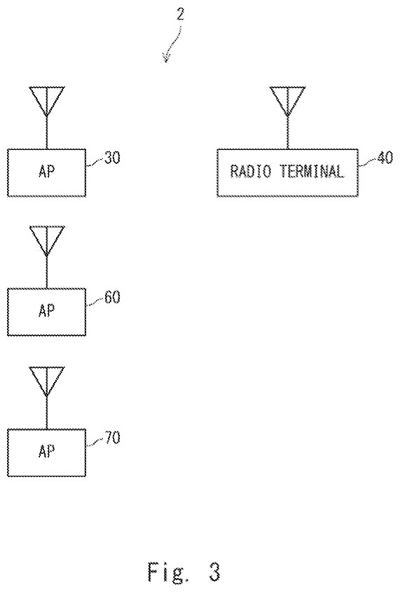

FIG. 3 shows an example of a communication system according to the second example embodiment. In FIG. 3, the communication system 2 includes APs 30, 60 and 70, and a radio terminal 40.

It is assumed that, as of this point in time, the in-use channel of the radio terminal 40 is set as the radio channel of the AP 30 and the standby channel thereof is set as the radio channel of the AP 70. In this state, firstly, the radio terminal 40 according to the second example embodiment determines whether or not the channel switching between the in-use channel and the standby channel described in the first example embodiment needs to be performed. Then, when the radio terminal 40 determines that the channel switching between the in-use channel and the standby channel does not need to be performed, the radio terminal 40 determines whether or not a handover for the standby channel needs to be performed. That is, the AP 60 is a “handover (HO) destination candidate access point”. Then, when the radio channel of the AP 60 is set as a HO candidate channel, the radio terminal 40 determines whether or not the radio channel set as the HO candidate channel should be switched from the HO candidate channel to the standby channel. It should be noted that a relative value of a “third communication quality parameter value” for the HO candidate channel relative to the second communication quality parameter value for the standby channel is larger than a predetermined threshold (hereinafter also referred to as a “third threshold”). Note that although only one HO destination candidate access point, which is the AP 60, is included in the communication system 2 for simplifying the description, the number of HO destination candidate access points included in the communication system 2 is not limited to one.

### Example of Configuration of Radio Terminal

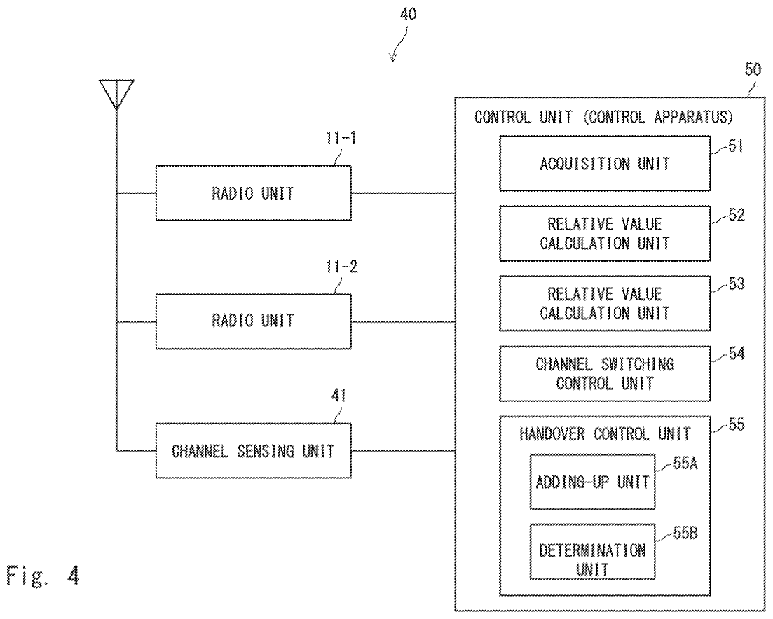

FIG. 4 is a block diagram showing an example of a radio terminal including a control apparatus according to the second example embodiment. In FIG. 4, the radio terminal 40 includes radio units 11-1 and 11-2, a channel sensing unit 41, and a control unit (a control apparatus) 50. Although one antenna is commonly used by both the radio units 11-1 and 11-2 in the radio terminal 40 shown in FIG. 4, the configuration of the radio terminal 40 is not limited to this example. That is, the radio terminal 40 may include an antenna corresponding to the radio unit 11-1 and an antenna corresponding to the radio unit 11-2, respectively. Although the number of radio units 11 is two in this example, it is not limited to two. That is, the number of radio units 11 may be three or larger.

The channel sensing unit 41 is a functional unit that performs measurement for a communication quality parameter(s) of the HO candidate channel.

In FIG. 4, the control unit (the control apparatus) 50 includes an acquisition unit 51, a relative value calculation unit (a first relative value calculation unit) 52, a relative value calculation unit (a second relative value calculation unit) 53, a channel switching control unit 54, and a handover control unit 55.

Similarly to the acquisition unit 21 in the first example embodiment, the acquisition unit 51 acquires first and second communication quality parameter values. The acquisition unit 51 further acquires a “third communication quality parameter value” for a radio channel that is the radio channel of the HO destination candidate access point (in this example, the AP 60) and is set as the HO candidate channel.

Similarly to the relative value calculation unit 22 in the first example embodiment, the relative value calculation unit 52 calculates a “first relative value”.

The relative value calculation unit 53 calculates a relative value (hereinafter also referred to as a “second relative value”) of the third communication quality parameter value acquired by the acquisition unit 51 relative to the second communication quality parameter value acquired by the acquisition unit 51. The “second relative value” may be a ratio of the third communication quality parameter value to the second communication quality parameter value, or a difference obtained by subtracting the second communication quality parameter value from the third communication quality parameter value.

Similarly to the channel switching control unit 23 in the first example embodiment, the channel switching control unit 54 determines whether or not the radio channel set as the standby channel should be switched from the standby channel to the in-use channel based on a comparison result obtained by comparing the first relative value calculated by the relative value calculation unit 52 with the first threshold. For example, when the calculated first relative value is larger than the first threshold, the channel switching control unit 54 determines that the radio channel set as the standby channel should be switched from the standby channel to the in-use channel.

When it is determined that the first relative value is lower than or equal to than the first threshold in the channel switching control unit 54, the handover control unit 55 determines whether or not a handover for switching the radio channel set as the HO candidate channel from the HO candidate channel to the standby channel should be performed based on the second relative value calculated by the relative value calculation unit 53.

For example, as shown in FIG. 4, the handover control unit 55 includes an adding-up unit 55A and a determination unit 55B.

The adding-up unit 55A calculates an added-up value obtained by adding up a plurality of second relative values calculated in an “adding-up target period”. The determination unit 55B determines whether or not the aforementioned handover should be performed based on the added-up value calculated by the adding-up unit 55A and a threshold (hereinafter also referred to as a “second threshold”). For example, when the added-up value calculated by the adding-up unit 55A is larger than the second threshold, the determination unit 55B determines that the handover should be performed. As a result, the handover control unit 55 performs the handover for switching the radio channel set as the HO candidate channel from the HO candidate channel to the standby channel. Note that when the added-up value calculated by the adding-up unit 55A is lower than or equal to the second threshold, the above-described handover is not performed and the radio channel set as the standby channel is maintained.

Note that, for example, the above-described “adding-up target period” may be reset (i.e., initialized) when the channel switching between the in-use channel and the standby channel is performed. Further, the “adding-up target period” may be reset when it is determined that the above-described handover should be performed. Further, the “adding-up target period” may be reset, in a state in which neither the channel switching between the in-use channel and the standby channel nor the handover is performed, when the process for determining whether or not the handover for the standby channel needs to be performed is performed a predetermined number of times. Further, when the “adding-up target period” is reset, the above-described “added-up value” and an “adding-up count” (which will be described later) may be cleared (e.g., set to zero).

### Example of Operation of Radio Terminal

An example of processing operations performed by the radio terminal 40 having the above-described configuration will be described. In particular, processing operations performed by the control unit (the control apparatus) 50 will be described hereinafter.

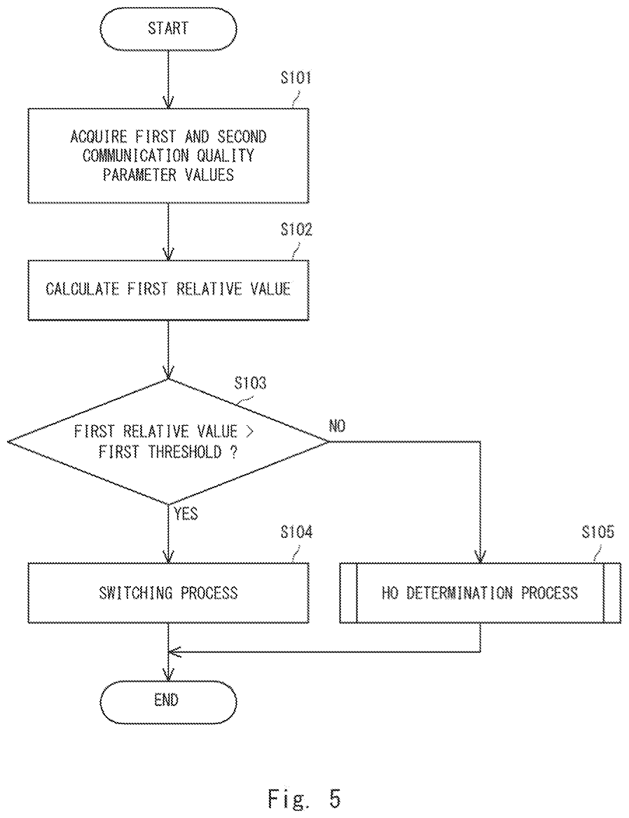

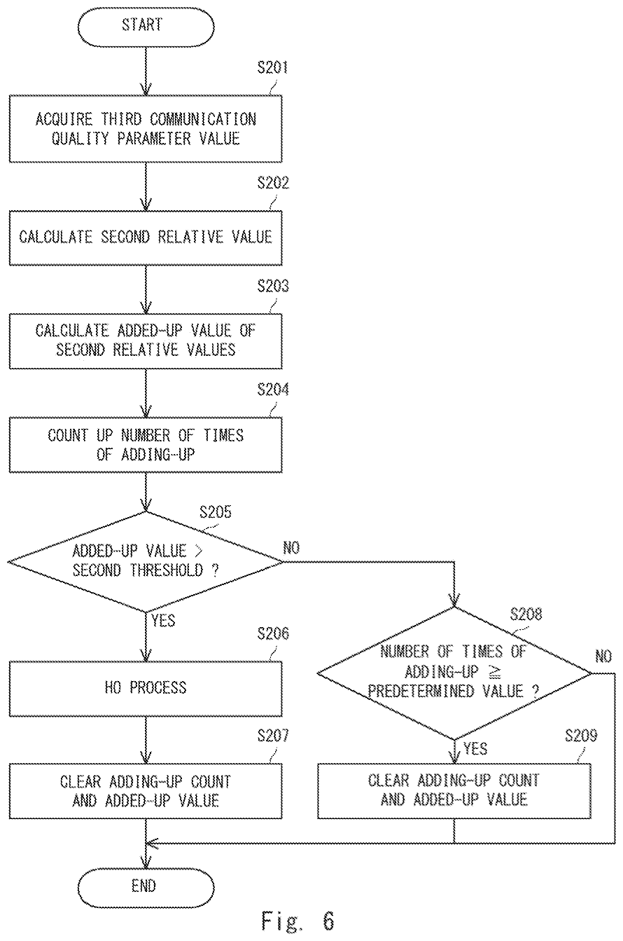

Each of FIGS. 5 and 6 is a flowchart showing an example of processing operations performed by the control apparatus according to the second example embodiment. The flow shown in FIG. 5 is performed, for example, at regular intervals.

The acquisition unit 51 acquires first and second communication quality parameter values (Step S101).

The relative value calculation unit 52 calculates a “first relative value” (Step S102).

The channel switching control unit 54 determines whether or not the first relative value is larger than the first threshold (Step S103).

When the first relative value is larger than the first threshold (Yes in Step S103), the channel switching control unit 54 performs the switching process (Step S104). That is, the channel switching control unit 54 switches the radio channel set as the standby channel from the standby channel to the in-use channel.

When the first relative value is lower than or equal to the first threshold (No in Step S103), the process flow proceeds to an HO determination process in a step S105.

In the HO determination process, the acquisition unit 51 acquires a “third communication quality parameter value” (Step S201).

The relative value calculation unit 53 calculates a “second relative value” (Step S202).

The handover control unit 55 calculates an added-up value of second relative values (Step S203) and counts up (increments) the number of times of adding-up (Step S204).

The handover control unit 55 determines whether or not the calculated added-up value is larger than the second threshold (Step S205).

When the calculated added-up value is larger than the second threshold (Yes in Step S205), the handover control unit 55 performs the HO process (Step S206). That is, the handover control unit 55 switches the radio channel set as the HO candidate channel from the HO candidate channel to the standby channel. Then, the handover control unit 55 clears the adding-up count and the added-up value (i.e., sets them to zero) (Step S207). With this, one HO determination process is finished.

When the calculated added-up value is lower than or equal to the second threshold (No in Step S205), the handover control unit 55 determines whether or not the number of times of adding-up is equal to or larger than a predetermined number (Step S208).

When the number of times of adding-up is equal to or larger than the predetermined number (Yes in Step S208), the handover control unit 55 clears the adding-up count and the added-up value (i.e., sets them to zero) (Step S209). With this, one HO determination process is finished. When the number of times of adding-up is smaller than the predetermined number (No in Step S208), one HO determination process is finished.

As described above, according to the second example embodiment, in the control unit (the control apparatus) 50, the handover control unit 55 determines whether or not a handover for switching the radio channel set as the HO candidate channel from the HO candidate channel to the standby channel should be performed based on the second relative value calculated by the relative value calculation unit 53.

By the above-described configuration of the control apparatus 50, it is possible to prevent ineffective HO from being performed and thereby to perform effective HO. That is, for example, it is conceivable that a HO for the standby channel is performed on the condition that the received signal strength (i.e., the absolute value) of the standby channel has decreased beyond a predetermined threshold. In this case, since the communication quality of the HO candidate channel is not taken into consideration, there is a possibility that an ineffective HO may be performed. Further, in this case, there is a possibility that the radio channel of the standby channel is maintained in a situation where the received signal strength (i.e., the absolute value) of the standby channel is slightly larger than the predetermined threshold but the communication quality cannot be considered to be satisfactory (i.e., there is a possibility that the so-called “unsatisfactory state continuation problem” may occur). In contrast to this, by the above-described configuration of the control apparatus 50, it is possible to determine whether or not a HO needs to be performed based on the second relative value. Therefore, it is possible to perform a HO for switching the radio channel set as the HO candidate channel from the HO candidate channel to the standby channel when it is expected that, by doing so, the communication quality will be significantly improved, and to prevent the HO from being performed when it is not expected that the communication quality will be significantly improved. Further, the “unsatisfactory-state continuation problem” can also be solved by the above-described configuration of the control apparatus 50. It should be noted that the processing cost for a HO is higher than that for channel switching between an in-use channel and a standby channel both of which are already established. Therefore, it is possible to reduce the processing cost by preventing an inefficient HO from being performed.

Further, the handover control unit 55 determines whether or not a handover for switching the radio channel set as the HO candidate channel from the HO candidate channel to the standby channel should be performed based on the added-up value of second relative values.

By the above-described configuration of the control apparatus 50, it is possible to prevent a HO from occurring due to momentary variations (e.g., only one momentary change) in a communication quality parameter value of the standby channel. That is, for example, in the case where a HO for a standby channel is performed on the condition that the received signal strength (i.e., absolute value) of the standby channel has decreased beyond a predetermined threshold, a HO will be performed even when the communication quality parameter value of the standby channel has momentarily decreased beyond the predetermined threshold (e.g., has decreased beyond the predetermined threshold only once). However, in such cases, there may be cases where it is advantageous not to perform a HO in consideration of the processing cost for the HO. In contrast, by the above-described configuration of the control apparatus 50, whether a HO needs to be performed or not is determined based on the added-up value of second relative values, so that it is possible to prevent a HO from occurring due to momentary variations (e.g., only one momentary change) in the communication quality parameter value of the standby channel. It should be noted that it is also possible to prevent a HO from occurring due to momentary variations (e.g., only one momentary change) in the communication quality parameter value of the standby channel by counting the number of times of determinations that the second relative value is smaller than the predetermined threshold and performing a HO only when this counted number of times reaches a predetermined number or larger. However, in this case, since the magnitude of the second relative value is not taken into consideration, there is a possibility that it takes time until a HO is performed. In contrast, according to the above-described configuration of the control apparatus 50, whether a HO needs to be performed or not is determined based on the added-up value of second relative values, so that when second relative values are large and hence the added-up value thereof rapidly increases, a HO can be performed early.

Note that although the above description has been made on the assumption that the radio terminal 40 includes the channel sensing unit 41, the present disclosure is not limited to this example. That is, the radio terminal 40 may not include the channel sensing unit 41. In this case, a carrier sensing unit (not shown) provided in the radio unit 11 in which the standby channel is set may measure the communication quality parameter of the HO candidate channel.

### Third Example Embodiment

A third example embodiment relates to an example embodiment in which an “available bandwidth value” is used as the communication quality parameter value.

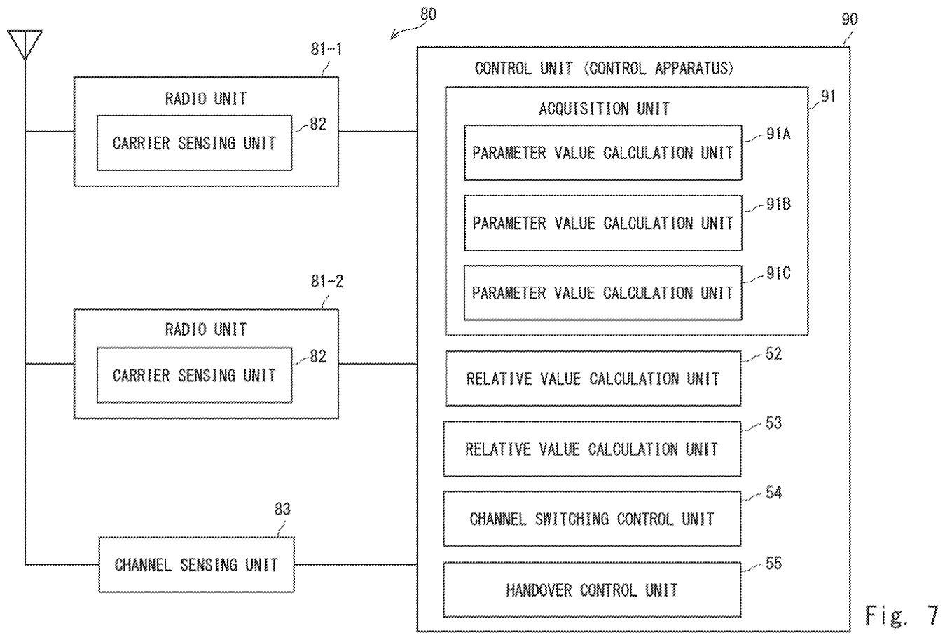

FIG. 7 is a block diagram showing an example of a radio terminal including a control apparatus according to the third example embodiment. In FIG. 7, the radio terminal (the radio communication apparatus) 80 includes radio units 81-1 and 81-2, a channel sensing unit 83, and a control unit (a control apparatus) 70. Although one antenna is commonly used by all of the radio units 81-1 and 81-2, and the channel sensing unit 83 in the radio terminal 80 shown in FIG. 7, the configuration of the radio terminal 80 is not limited to this example. That is, the radio terminal 80 may include antennas corresponding to the radio units 81-1 and 81-2, and the channel sensing unit 83, respectively.

Each of the radio units 81-1 and 81-2 performs a transmission radio process for a transmission signal and a reception radio process for a reception signal by using a set radio channel. Here, it is assumed that the aforementioned first radio channel is set in the radio unit 81-1, and communication is being performed by the radio unit 81-1. Further, it is assumed that the aforementioned second radio channel is set in the radio unit 81-2, and the radio unit 81-2 is in a standby state.

Each of the radio units 81-1 and 81-2 includes a carrier sensing unit 82, and measures a received signal strength (RSSI) and a busy time for a set radio channel. That is, in this example, the radio unit 81-1 measures the RSSI and the busy time of the in-use channel, and the radio unit 81-2 measures the RSSI and the busy time of the standby channel.

The channel sensing unit 83 measures the RSSI and the busy time for the HO candidate channel.

The control unit (the control apparatus) 90 includes an acquisition unit 91, a relative value calculation unit (a first relative value calculation unit) 52, a relative value calculation unit (a second relative value calculation unit) 53, a channel switching control unit 54, and a handover control unit 55.

The acquisition unit 91 includes parameter value calculation units 91A, 91B and 91C.

The parameter value calculation unit 91A calculates a first available bandwidth value for the in-use channel as the first communication quality parameter value. For example, the parameter value calculation unit 91A calculates the first available bandwidth value based on the received signal strength and the busy time for the in-use channel. Specifically, the parameter value calculation unit 91A specifies a maximum data rate corresponding to the received signal strength for the in-use channel by using a correspondence relationship between the received signal strength and the maximum data rate. Then, the parameter value calculation unit 91A calculates a ratio of an available time in the in-use channel based on the busy time for the in-use channel. Then, the parameter value calculation unit 91A calculates the first available bandwidth value by multiplying the specified maximum data rate by the calculated ratio of the available time.

The parameter value calculation unit 91B calculates a second available bandwidth value for the standby channel as the second communication quality parameter value. For example, the parameter value calculation unit 91B calculates the second available bandwidth value based on the received signal strength and the busy time for the standby channel. Specifically, the parameter value calculation unit 91B specifies a maximum data rate corresponding to the received signal strength for the standby channel by using a correspondence relationship between the received signal strength and the maximum data rate. Then, the parameter value calculation unit 91B calculates a ratio of an available time in the standby channel based on the busy time for the standby channel. Then, the parameter value calculation unit 91B calculates the second available bandwidth value by multiplying the specified maximum data rate by the calculated ratio of the available time.

The parameter value calculation unit 91C calculates a third available bandwidth value for the HO candidate channel as the third communication quality parameter value. For example, the parameter value calculation unit 91C calculates the third available bandwidth value based on the received signal strength and the busy time for the HO candidate channel. Specifically, the parameter value calculation unit 91C specifies a maximum data rate corresponding to the received signal strength for the HO candidate channel by using a correspondence relationship between the received signal strength and the maximum data rate. Then, the parameter value calculation unit 91C calculates a ratio of an available time in the HO candidate channel based on the busy time for the HO candidate channel. Then, the parameter value calculation unit 91C calculates the third available bandwidth value by multiplying the specified maximum data rate by the calculated ratio of the available time.

Note that although the above description has been made on the assumption that the radio terminal 80 includes the channel sensing unit 83, the present disclosure is not limited to this example. That is, the radio terminal 80 may not include the channel sensing unit 83. In this case, the carrier sensing unit 82 of the radio unit 81 in which the standby channel is set may measure the RSSI and the busy time for the HO candidate channel.

Further, the method for obtaining the first, second and third available bandwidth values is not limited to the above-described method. For example, the radio terminal 80 transmits a “packet train (a group of packets for measurement)” to a counterpart communication apparatus, which communicates with the radio terminal 80, by using each of the in-use channel, the standby channel, and the HO candidate channel. The packet train includes a plurality of packets, and two adjacent packets in the packet train are transmitted at a predetermined temporal interval (hereinafter also referred to as a “packet interval”). Then, the aforementioned counterpart communication apparatus feeds back, for each of the in-use channel, the standby channel, and the HO candidate channel, variations (i.e., jitter) of the packet intervals in the packet train received through that channel to the radio terminal 80. Then, the radio terminal 80 estimates an available bandwidth value for each of the in-use channel, the standby channel and the HO candidate channel based on the fed-back jitter.

### Fourth Example Embodiment

A fourth example embodiment relates to a method for creating a “HO candidate channel list”. Note that the fundamental configurations of a radio terminal and a control apparatus according to the fourth example embodiment are similar to those of the radio terminal 80 and the control apparatus 90 according to the third example embodiment. Therefore, they will be described with reference to FIG. 7.

In the fourth example embodiment, the channel sensing unit 83 measures the RSSI and the busy time for each of a plurality of sensing target channels.

The parameter value calculation unit 91C calculates an available bandwidth value for each of the sensing target channels.

The relative value calculation unit 53 calculates a relative value of an available bandwidth value of each of the sensing target channels relative to the second available bandwidth value for the standby channel.

The handover control unit 55 registers, in a HO candidate channel list, a sensing target channel(s) of which the relative value(s) calculated by the relative value calculation unit 53 is larger than the third threshold. In this way, the HO candidate channel list is created.

In the HO determination process described in the second example embodiment, the handover control unit 55 calculates an added-up value for each of the entries (i.e., each of the HO candidate channels) registered in the HO candidate channel list.

Note that the above-described process for creating a HO candidate channel list may be performed when a condition that the relative value of the first communication quality parameter value acquired by the acquisition unit 91 relative to the second communication quality parameter value acquired by the acquisition unit 91 is larger than a fourth threshold is satisfied. Alternatively or additionally, the above-described process for creating a HO candidate channel list may be performed when the process for switching the channel between the in-use channel and the standby channel is performed, when the HO process is performed, or when the number of times of adding-up reaches a predetermined number or larger.

### Other Example Embodiment

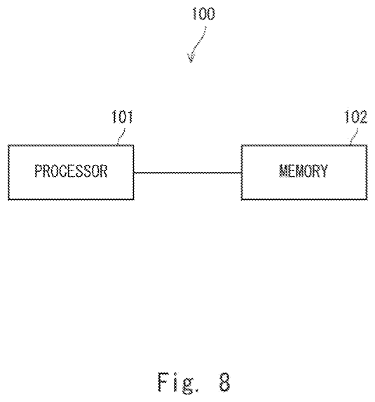

FIG. 8 shows an example of a hardware configuration of a control apparatus. In FIG. 8, a control apparatus 100 includes a processor 101 and a memory 102. The processor 101 may be, for example, a microprocessor, an MPU (Micro Processing Unit), or a CPU (Central Processing Unit). The processor 101 may include a plurality of processors. The memory 102 is composed of a combination of a volatile memory and a nonvolatile memory. The memory 102 may include a storage located remotely from the processor 101. In this case, the processor 101 may access the memory 102 through an I/O interface (not shown).

Each of the control apparatuses 20, 50 and 90 according to the first to fourth example embodiments may have the hardware configuration shown in FIG. 8. Each of the acquisition units 21, 51 and 91, the relative value calculation units 22, 52 and 53, the channel switching control units 23 and 54, and the handover control unit 55 of the control apparatuses 20, 50 and 90 according to the first to fourth example embodiments may be implemented by having the processor 101 load a program stored in the memory 102 and execute the loaded program. The program may be stored in various types of non-transitory computer readable media and thereby supplied to each of the control apparatuses 20, 50 and 90. Examples of the non-transitory computer readable media include a magnetic recording medium (such as a flexible disk, a magnetic tape, and a hard disk drive) and a magneto-optic recording medium (such as a magneto-optic disk). Further, examples of the non-transitory computer readable media include CD-ROM (Read Only Memory), CD-R, and CD-R/W. Further, examples of the non-transitory computer readable media include a semiconductor memory. The semiconductor memory includes, for example, a mask ROM, a PROM (Programmable ROM), an EPROM (Erasable PROM), a flash ROM, and a RAM (Random Access Memory). Further, the programs may be supplied to each of the control apparatuses 20, 50 and 90 by using various types of transitory computer readable media. Examples of the transitory computer readable media include an electrical signal, an optical signal, and an electromagnetic wave. The transitory computer readable media can be used to supply a program to each of the control apparatuses 20, 50 and 90 through a wired communication line (e.g., an electric wire and an optical fiber) or a radio communication line.

Although the present invention is described above with reference to example embodiments, the present invention is not limited to the above-described example embodiments. Various modifications that can be understood by those skilled in the art can be made to the configuration and details of the present invention within the scope of the invention.

The whole or part of the example embodiments disclosed above can be described as, but not limited to, the following supplementary notes.

### (Supplementary Note 1)

A control apparatus configured to control communication of a radio communication apparatus capable of performing communication by using a plurality of radio channels, the control apparatus comprising:

acquisition means for acquiring a communication quality parameter value for each of a radio channel set as an in-use channel and a radio channel set as a standby channel, the in-use channel being a channel that is currently used for communication, and the standby channel being a channel that is not currently used for the communication;

first relative value calculation means for calculating a first relative value of a second communication quality parameter value relative to a first communication quality parameter value, the second communication quality parameter value being the acquired communication quality parameter value for the standby channel, and the first communication quality parameter value being the acquired communication quality parameter value for the in-use channel; and

channel switching control means for determining whether or not the radio channel set as the standby channel should be switched from the standby channel to the in-use channel based on a comparison result obtained by comparing the calculated first relative value with a first threshold.

### (Supplementary Note 2)

The control apparatus described in Supplementary note 1, wherein when the calculated first relative value is larger than the first threshold, the channel switching control means determines that the radio channel, which is the standby channel, is switched from the standby channel to the in-use channel.

### (Supplementary Note 3)

The control apparatus described in Supplementary note 1 or 2, wherein

when the radio channel set as the standby channel is a radio channel of one access point, the acquisition means acquires a third communication quality parameter value for a radio channel that is a radio channel of a handover (HO) destination candidate access point other than the one access point, and is set as a HO candidate channel, and

the control apparatus comprises:

second relative value calculation means for calculating a second relative value of the acquired third communication quality parameter value relative to the acquired second communication quality parameter value; and

handover control means for determining, when it is determined that the calculated first relative value is lower than or equal to the first threshold in the channel switching control means, whether or not a handover for switching the radio channel set as the HO candidate channel from the HO candidate channel to the standby channel should be performed based on the calculated second relative value.

### (Supplementary Note 4)

The control apparatus described in Supplementary note 3, wherein

the handover control means comprises:

adding-up means for calculating an added-up value obtained by adding up a plurality of second relative values calculated in an adding-up target period; and

determination means for determining whether or not the handover should be performed based on the calculated added-up value and the second threshold.

### (Supplementary Note 5)

The control apparatus described in Supplementary note 3, wherein the second relative value is a ratio of the acquired third communication quality parameter value for a candidate channel to the acquired second communication quality parameter value, or a difference obtained by subtracting the acquired second communication quality parameter value from the acquired third communication quality parameter value.

### (Supplementary Note 6)

The control apparatus described in any one of Supplementary notes 1 to 5, wherein the first relative value is a ratio of the acquired second communication quality parameter value to the acquired first communication quality parameter value, or a difference obtained by subtracting the acquired first communication quality parameter value from the acquired second communication quality parameter value.

### (Supplementary Note 7)

The control apparatus described in Supplementary note 3, wherein

the first communication quality parameter value is a first available bandwidth value for the in-use channel,

the second communication quality parameter value is a second available bandwidth value for the standby channel, and

the third communication quality parameter value is a third available bandwidth value for the HO candidate channel.

### (Supplementary Note 8)

The control apparatus described in Supplementary note 7, wherein

the acquisition means comprises:

first parameter value calculation means for calculating the first available bandwidth value based on a received signal strength and a busy time for the in-use channel;

second parameter value calculation means for calculating the second available bandwidth value based on a received signal strength and a busy time for the standby channel; and

third parameter value calculation means for calculating the third available bandwidth value based on a received signal strength and a busy time for the HO candidate channel.

### (Supplementary Note 9)

The control apparatus described in Supplementary note 8, wherein the first parameter value calculation means specifies a maximum data rate corresponding to the received signal strength for the in-use channel by using a correspondence relationship between the received signal strength and the maximum data rate, calculates a ratio of an available time in the in-use channel based on the busy time for the in-use channel, and calculates the first available bandwidth value by multiplying the specified maximum data rate by the calculated ratio of the available time.

### (Supplementary Note 10)

A radio terminal apparatus comprising a control apparatus described in any one of Supplementary notes 1 to 9.

### (Supplementary Note 11)

A control method for controlling communication of a radio communication apparatus capable of performing communication by using a plurality of radio channels, the control method comprising:

acquiring a communication quality parameter value for each of a radio channel set as an in-use channel and a radio channel set as a standby channel, the in-use channel being a channel that is currently used for communication, and the standby channel being a channel that is not currently used for the communication;

calculating a first relative value of a second communication quality parameter value relative to a first communication quality parameter value, the second communication quality parameter value being the acquired communication quality parameter value for the standby channel, and the first communication quality parameter value being the acquired communication quality parameter value for the in-use channel; and

determining whether or not the radio channel set as the standby channel should be switched from the standby channel to the in-use channel based on a comparison result obtained by comparing the calculated first relative value with a first threshold.

### (Supplementary Note 12)

A non-transitory computer readable medium storing a control program for causing a control apparatus configured to control communication of a radio communication apparatus capable of performing communication by using a plurality of radio channels to perform processes including:

acquiring a communication quality parameter value for each of a radio channel set as an in-use channel and a radio channel set as a standby channel, the in-use channel being a channel that is currently used for communication, and the standby channel being a channel that is not currently used for the communication;

calculating a first relative value of a second communication quality parameter value relative to a first communication quality parameter value, the second communication quality parameter value being the acquired communication quality parameter value for the standby channel, and the first communication quality parameter value being the acquired communication quality parameter value for the in-use channel; and

determining whether or not the radio channel set as the standby channel should be switched from the standby channel to the in-use channel based on a comparison result obtained by comparing the calculated first relative value with a first threshold.

### REFERENCE SIGNS LIST

1 COMMUNICATION SYSTEM
2 COMMUNICATION SYSTEM
10 RADIO TERMINAL
11 RADIO UNIT
20 CONTROL UNIT (CONTROL APPARATUS)
21 ACQUISITION UNIT
22 RELATIVE VALUE CALCULATION UNIT (FIRST RELATIVE VALUE CALCULATION UNIT)
23 CHANNEL SWITCHING CONTROL UNIT
30 ACCESS POINT (AP)
40 RADIO TERMINAL
41 CHANNEL SENSING UNIT
50 CONTROL UNIT (CONTROL APPARATUS)
51 ACQUISITION UNIT
52 RELATIVE VALUE CALCULATION UNIT (FIRST RELATIVE VALUE CALCULATION UNIT)
53 RELATIVE VALUE CALCULATION UNIT (SECOND RELATIVE VALUE CALCULATION UNIT)
54 CHANNEL SWITCHING CONTROL UNIT
55 HANDOVER CONTROL UNIT
55A ADDING-UP UNIT
55B DETERMINATION UNIT
70 CONTROL UNIT (CONTROL APPARATUS)
80 RADIO TERMINAL
81 RADIO UNIT
82 CARRIER SENSING UNIT
83 CHANNEL SENSING UNIT
90 CONTROL UNIT (CONTROL APPARATUS)
91 ACQUISITION UNIT
91A PARAMETER VALUE CALCULATION UNIT
91B PARAMETER VALUE CALCULATION UNIT
91C PARAMETER VALUE CALCULATION UNIT

What is claimed is:

1. A control apparatus configured to control communication of a radio communication apparatus capable of performing communication by using a plurality of radio channels, the control apparatus comprising:
at least one memory configured to store instructions; and
at least one processor configured to execute, according to the instructions, a process comprising:
acquiring a communication quality parameter value for each of a radio channel set as an in-use channel and a radio channel set as a standby channel, the in-use channel being a channel that is currently used for communication, and the standby channel being a channel that is not currently used for the communication;
calculating a first relative value of a second communication quality parameter value relative to a first communication quality parameter value, the second communication quality parameter value being the acquired communication quality parameter value for the standby channel, and the first communication quality parameter value being the acquired communication quality parameter value for the in-use channel; and
determining whether or not the radio channel set as the standby channel should be switched from the standby channel to the in-use channel based on a comparison result obtained by comparing the calculated first relative value with a first threshold.

2. The control apparatus according to claim 1, wherein the first determining comprises determining, when the calculated first relative value is larger than the first threshold, that the radio channel, which is the standby channel, is switched from the standby channel to the in-use channel.

3. The control apparatus according to claim 1, wherein
the process further comprising:
acquiring, when the radio channel set as the standby channel is a radio channel of one access point, a third communication quality parameter value for a radio channel that is a radio channel of a handover (HO) destination candidate access point other than the one access point, and is set as a HO candidate channel;
calculating a second relative value of the acquired third communication quality parameter value relative to the acquired second communication quality parameter value; and
second determining, when it is determined that the calculated first relative value is lower than or equal to the first threshold, whether or not a handover for switching the radio channel set as the HO candidate channel from the HO candidate channel to the standby channel should be performed based on the calculated second relative value.

4. The control apparatus according to claim 3, wherein
the second determining comprises:
calculating an added-up value obtained by adding up a plurality of second relative values calculated in an adding-up target period; and
determining whether or not the handover should be performed based on the calculated added-up value and the second threshold.

5. The control apparatus according to claim 3, wherein the second relative value is a ratio of the acquired third communication quality parameter value for a candidate channel to the acquired second communication quality parameter value, or a difference obtained by subtracting the acquired second communication quality parameter value from the acquired third communication quality parameter value.

6. The control apparatus according to claim 1, wherein the first relative value is a ratio of the acquired second communication quality parameter value to the acquired first communication quality parameter value, or a difference obtained by subtracting the acquired first communication quality parameter value from the acquired second communication quality parameter value.

7. The control apparatus according to claim 3, wherein
the first communication quality parameter value is a first available bandwidth value for the in-use channel,
the second communication quality parameter value is a second available bandwidth value for the standby channel, and
the third communication quality parameter value is a third available bandwidth value for the HO candidate channel.

8. The control apparatus according to claim 7, wherein
the acquiring comprises:
calculating the first available bandwidth value based on a received signal strength and a busy time for the in-use channel;
calculating the second available bandwidth value based on a received signal strength and a busy time for the standby channel; and
calculating the third available bandwidth value based on a received signal strength and a busy time for the HO candidate channel.

9. The control apparatus according to claim 8, wherein the calculating of the first available bandwidth value comprises:
specifying a maximum data rate corresponding to the received signal strength for the in-use channel by using a correspondence relationship between the received signal strength and the maximum data rate,
calculating a ratio of an available time in the in-use channel based on the busy time for the in-use channel, and
calculating the first available bandwidth value by multiplying the specified maximum data rate by the calculated ratio of the available time.

10. A radio terminal apparatus comprising a control apparatus according to claim 1.

11. A control method for controlling communication of a radio communication apparatus capable of performing communication by using a plurality of radio channels, the control method comprising:
acquiring a communication quality parameter value for each of a radio channel set as an in-use channel and a radio channel set as a standby channel, the in-use channel being a channel that is currently used for communication, and the standby channel being a channel that is not currently used for the communication;
calculating a first relative value of a second communication quality parameter value relative to a first communication quality parameter value, the second communication quality parameter value being the acquired communication quality parameter value for the standby channel, and the first communication quality parameter value being the acquired communication quality parameter value for the in-use channel; and
determining whether or not the radio channel set as the standby channel should be switched from the standby channel to the in-use channel based on a comparison result obtained by comparing the calculated first relative value with a first threshold.

12. A non-transitory computer readable medium storing a control program for causing a control apparatus configured to control communication of a radio communication apparatus capable of performing communication by using a plurality of radio channels to perform processes including:
acquiring a communication quality parameter value for each of a radio channel set as an in-use channel and a radio channel set as a standby channel, the in-use channel being a channel that is currently used for communication, and the standby channel being a channel that is not currently used for the communication;
calculating a first relative value of a second communication quality parameter value relative to a first communication quality parameter value, the second communication quality parameter value being the acquired communication quality parameter value for the standby channel, and the first communication quality parameter value being the acquired communication quality parameter value for the in-use channel; and
determining whether or not the radio channel set as the standby channel should be switched from the standby channel to the in-use channel based on a comparison result obtained by comparing the calculated first relative value with a first threshold.
